(19) United States
(12) Patent Application Publication
(10) Pub. No.: US 2024/0077384 A1
(43) Pub. Date: Mar. 7, 2024

(54) SENSOR MODULE FOR DETECTING A VIBRATIONAL BEHAVIOR OF A COMPONENT AND INCLUDING A LEAK-PROOF LIGHT GUIDE

(71) Applicant: Aktiebolaget, SKF, Gõteborg (SE)

(72) Inventor: Olivier CHEVE, Chanceaux-sur-choisille (FR)

(21) Appl. No.: 18/455,792

(22) Filed: Aug. 25, 2023

(30) Foreign Application Priority Data
Sep. 2, 2022 (DE) 102022209131.0

(51) Int. Cl. G01M 13/045; G01H 11/08

(52) U.S. Cl. CPC G01M 13/045; G01H 11/08

(57) ABSTRACT

A sensor module (24) for detecting a mechanical vibration of a component. The sensor module (24) includes a base (26) to be secured on the component, a light emitter (50), a circuit board (28), and a casing (52). The circuit board (28) is mechanically connected to the base (26). The circuit board (28) has a first side (32) facing the base (26) and a second side (34). The light emitter (50) is disposed on the second side (34). The circuit board (28) is housed inside the casing (52). The casing (52) includes a cover (54) and a light guide (56) facing the light emitter (50). The cover (54) has a through-hole (60) inside which extends the light guide (56). One of the cover (54) or the light guide (56) is overmolded on the other.

### CROSS-REFERENCE TO RELATED APPLICATION

This application claim priority to German Application No. 102022209131.0, filed Sep. 2, 2022, the entirety of which is hereby incorporated by reference.

### FIELD

The present disclosure generally relates to a sensor module for detecting a vibrational behavior of a mechanical component, and, more specifically, toward a sensor module for detecting a vibrational behavior of an annular bearing component of a vehicle wheel, which sensor module is mountable on the vehicle wheel and configured to wirelessly transmit signals indicative of the detected vibrational behavior.

### BACKGROUND

Mechanical components are subjected to vibrations in various fields of technology. These vibrations may arise from the normal operation of a component or a machine or a system, but they could also indicate a defect or a failure of the component, machine or system. For example, vibrations occurring in rotating components, such as vehicle wheels, could indicate an imbalance or be indicative of bearing damage.

Regardless of whether the vibrations in question are related to normal operation or are indicative of a fault condition, there is a need to detect the vibrational behavior of such a component. Sensor modules can be used for this purpose, which sensor modules may include transmitters for wirelessly transmitting signals indicative of the detected vibrational behavior to a remote receiver.

A sensor module can also include a light emitter informing an operator of the status of said sensor module. For example, the light emitter emits a green light when the sensor module is working as it should, and the light emitter emits a red light if the sensor module has a problem during the acquisition of measures or during the transmission of said measures.

Many factors must be taken into account when designing such sensor modules including, for example, easy integration, robustness of the module, reliability, and precision of vibration detection.

The FIG. 1 shows a sensor module 2 of the state of the art having a light emitter 4 directly linked to a circuit board 6 of the sensor module 2, the sensor module 2 also comprising a casing 8 inside which is located said circuit board 6.

The casing 8 comprises a through-hole 10 and the sensor module 2 comprises a light guide 12 directly fixed on the circuit board 6 with centering pins 14 and disposed over the light emitter 4 in order to guide the light through the through-hole 10 of the casing 8. The through-hole 10 is tubular and the light guide 12 has a diameter similar to the diameter of said through-hole 10.

However, the assembly of this module is difficult due to an uneven centering of the circuit board 6, which is sometimes transversely offset by a few millimeters, introducing a difficulty to fit correctly the light guide 12 in the through-hole 10. The problem is generally solved by sorting the products at the end of the production, inducing a waste of components.

The sensor module 2 also comprises a potting material 16 injected between the circuit board 6 and the casing 8 in order to rigidify and stabilize the circuit board 6. However, the injection of the potting material 16 induces leakages of said potting material 16 through the through-hole 10 and despite the presence of the light guide 12. The current solution is to put a sticker on the casing 8 in order to stop the leakage.

There is thus a need to provide a sensor module for detecting a vibrational behavior of a mechanical component that comprises a light guide facilitating the assembly of said sensor module.

### SUMMARY

One object of the present disclosure is to provide a sensor module configured to detect a mechanical vibration of a component, the sensor module comprising:
a base configured to be secured on the component;
a light emitter;
a circuit board mechanically connected to the base and having a first side facing the base and a second side facing away from the base, the light emitter being disposed on the second side, facing away from the base; and
a casing inside which is housed the circuit board.

Advantageously, the casing comprises a cover and a light guide facing the light emitter, the cover comprising a through-hole through which the light emitted by the light emitter is able to pass and inside which extends the light guide, one of the cover or the light guide being overmolded on the other.

The cover and the light guide being overmolded on each other, no leakage can be induced through the through-hole. Furthermore, the light guide being part of the casing, there is no fitting issues of the light guide in the through-hole, even if the circuit board is transversely offset.

In one embodiment, the cover comprises a front part comprising the through-hole, and a mounting skirt extending from the front part and surrounding the circuit board.

Advantageously, the through-hole has a conical form.

The conical form permits an increased solidarization of the cover and the light guide.

Advantageously, the light guide is made of a translucent material.

According to one embodiment, the light guide comprises a main base and a tube extending from the main base towards the light emitter, the main base being in contact with the cover all around the through-hole of the cover, and the tube surrounding the light emitter, the width of the tube being larger than the width of the light emitter.

Due to the overmolding of the light guide, there is no direct fixation of the light guide on the circuit board. Thus, an uneven centering of the circuit board doesn't alter the assembly of the sensor module and the light emitter is well placed in front of the light guide.

Advantageously, the tube rests tightly against the second side of the circuit board.

In one embodiment, the sensor module comprises a potting material between the casing and the second side of the circuit board.

Advantageously, the potting material comprises a polymer.

Advantageously, the light emitter comprises a LED.

According to an embodiment, the circuit board comprises a piezoelectric vibration sensor.

One other object of the present disclosure is to provide a vehicle wheel assembly comprising:
a wheel having a component comprising studs and;
a sensor module as previously defined mounted on the studs of the wheel.

### BRIEF DESCRIPTION OF THE DRAWINGS

Other advantages and features of the present disclosure will appear from the detailed description of an embodiment of the present disclosure, which is a non-limiting example, illustrated on the appended drawings of which:

FIG. 1 is an already mentioned schematic front side view of light guide of the state of the art;

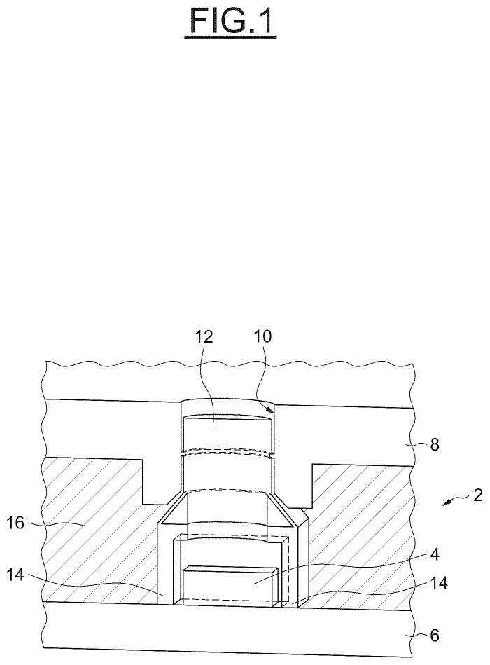

FIG. 2 is a front view of a vehicle wheel assembly according to the present disclosure;

FIG. 3 is a front view of a sensor module of the vehicle wheel assembly of FIG. 1 according to one embodiment;

FIG. 4 is a cross-section along IV-IV of FIG. 3; and

FIG. 5 is a view of a casing of the sensor module illustrated in FIG. 3.

### DETAILED DESCRIPTION

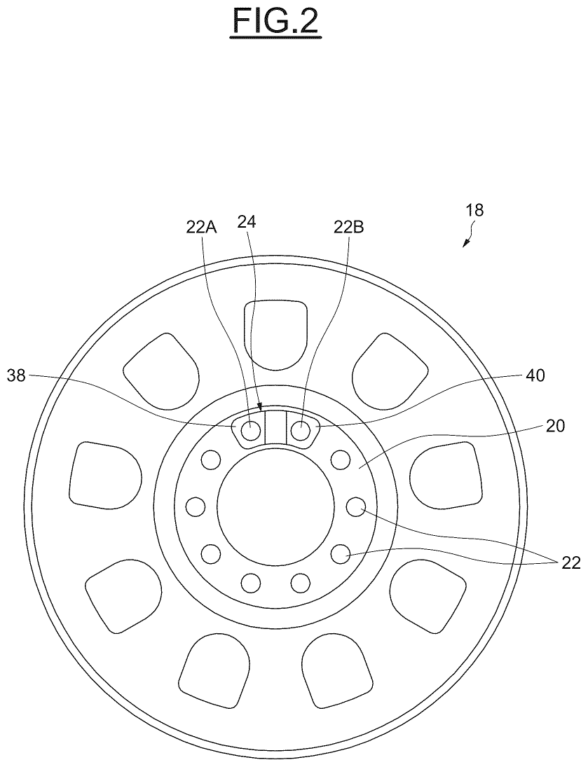

The FIG. 2 shows a vehicle wheel assembly 18 comprising a wheel having a component 20, for example a rim, comprising a plurality of studs 22 and a sensor module 24 mounted on a first stud 22A and a second stud 22B adjacent to the first stud 22A.

The sensor module 24 is configured to detect a mechanical vibration of the component 20. The detected mechanical vibration may be symptomatic of the vibrational behavior of an annular bearing component of the vehicle wheel assembly 18.

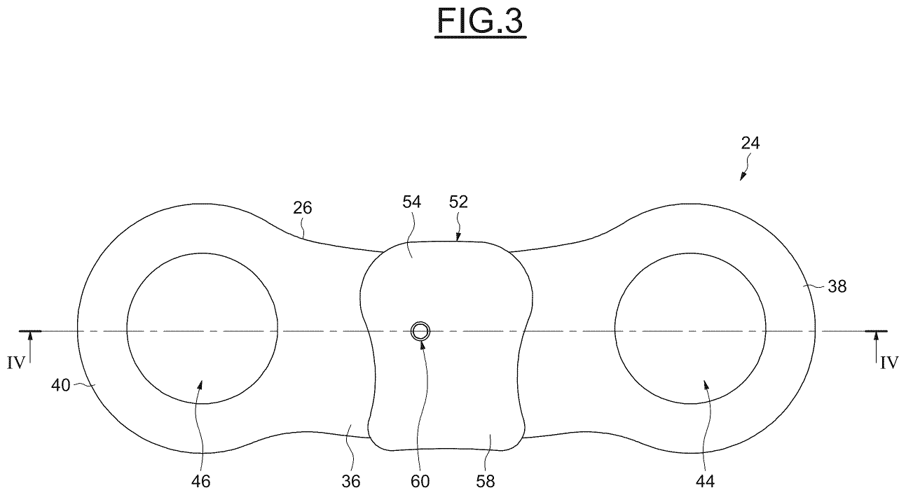

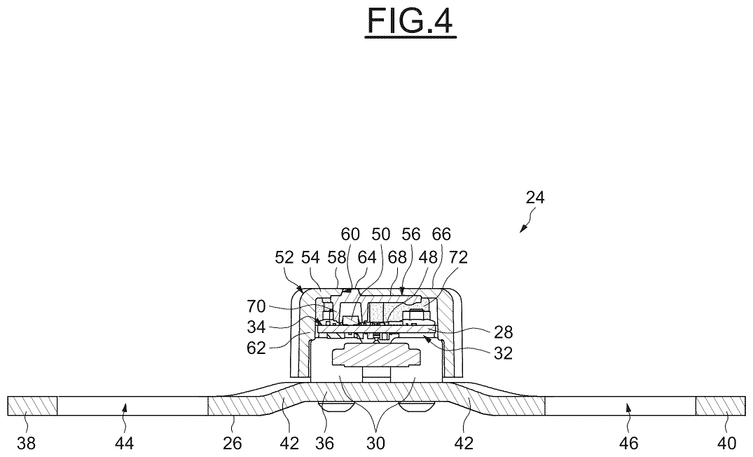

As shown on FIGS. 3 and 4, the sensor module 24 includes a base 26 and a circuit board 28 connected to the base 26 by spacers 30 transmitting the vibrations of the component 20 to the circuit board 28.

The circuit board 28 comprises a first side 32 facing the base 26 and a second side 34 facing away from the base 26. The first and second sides 32, 34 define the thickness of the circuit board 28.

The base 26 comprises a central portion 36, a first end portion 38 and a second end portion 40. The first end portion 38 is connected to one end of the central portion 36 and the second end portion 40 is connected to one opposite end of the central portion 36. The first and second end portions 38, 40 lie substantially in a same plane. The central portion 36 of the base 26 is offset from the plane of the first and second end portions 38, 40 and connected to these first and second end portions 38, 40 by ramps 42.

The first and second end portions 38, 40 of the base 26 are configured to be secured on the component 20 (FIG. 2). To this end, the first end portion 38 of the base 26 comprises a first opening 44 facing the first stud 22A, and the second end portion 40 comprises a second opening 46 facing the second stud 22B so that the sensor module 24 is secured to the component 20 with nuts (not illustrated) both engaged around the studs 22A, 22B.

The circuit board 28 also comprises a piezoelectric vibration sensor 48 mounted on the second side 34 of the circuit board 28. A vibration of the component 20 is thus transmitted by the studs 22A, 22B, the base 26, and the spacers 30 to the piezoelectric vibration sensor 48.

The circuit board 28 may also comprise a wireless transmitter and an antenna (not represented) mounted on the second side 34 of the circuit board 28. A battery (not represented) may also be mounted on the first side 32 of the circuit board 28.

The sensor module 24 also comprises a light emitter 50 disposed on the second side 34 of the circuit board 28, facing away from the base 26. The light emitter 50 comprises advantageously a LED, for example emitting a red and/or green light.

The sensor module 24 also includes a casing 52 inside which is housed the circuit board 28.

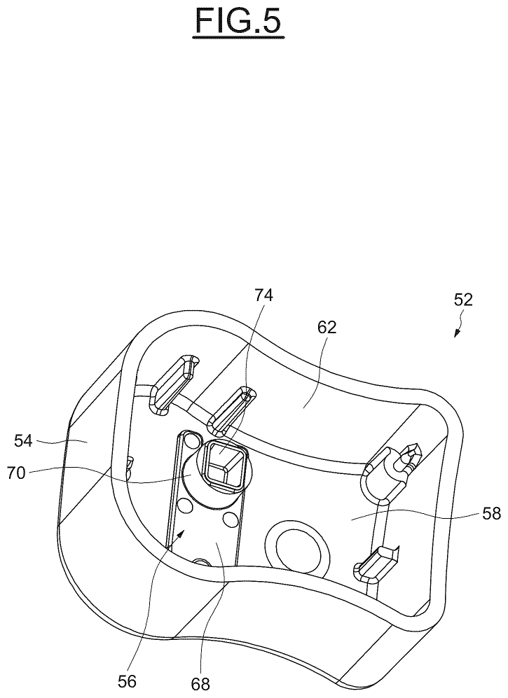

As shown on FIG. 5, the casing 52 comprises a cover 54 and a light guide 56 facing the light emitter 50, one of the cover 54 or the light guide 56 being overmolded on the other.

The cover 54 comprises a front part 58 comprising a through-hole 60 also facing the light emitter 50. The through-hole 60 is provided in the thickness of the front part 58. The through-hole 60 is centered on the main emission axis of the light emitter 50. The cover 54 also comprises a mounting skirt 62 extending from the front part 58 and surrounding the circuit board 28.

The light guide 56 extends inside the through-hole 60 of the cover 54. The through-hole 60 has a conical form, the base of the conical form being closer to the circuit board 28. The conical form permits an increased solidarization of the cover with the light guide 28 compared to a tubular form. The overmolding is more effective and the risk of leakage of a fluid through the through-hole 60 is very limited.

The light guide 56 comprises a flush surface 64 facing away the base 26 and formed at the same level of the main surface 66 of the front part of the cover 54 facing away the base 26. Alternatively, the light guide 56 may protrude with respect with the main surface 66 of the front part 58 or may be offset inside the through-hole 60.

Advantageously, the light guide 56 comprises a main base 68 and a tube 70 extending from the main base 68 towards the light emitter 50. The main base 68 is in contact with the cover 54 all around the through-hole 60 of the cover 54 in order to avoid any leakage.

The sensor module 24 comprises a potting material 72, for example a polymer, between the casing 52 and the second side 34 of the circuit board 28 in order to rigidify and stabilize the circuit board 28 and in order to fix the casing 52 to the circuit board 28. In the described embodiment, the potting material 72 is injected and any leakage through the through-hole 60 is prevented by the overmolded casing 52.

The tube 70 surrounds the light emitter 50 in order to guide the emitted light and in order to prevent the potting material 72 to enter the tube 70 and alter the emission of said light.

In one embodiment, the width of the tube 70 is larger than the width of the light emitter 50, and the tube 70 rests against the second side 34 of the circuit board 28. The tube 70 is sealingly engaged against the second side 34.

In the illustrated embodiment, the inner surface 74 of the tube 70 has a rectangular section larger than the light emitter 50 and both protects the light emitter 50 from the potting material 72 and permits a correct fitting of the light emitter 50 with the light guide 56 even if the circuit board 28 is transversely offset during the fabrication process. The inner volume of the tube 70 is also filled with a transparent silicone material in order to further protect the light emitter 50 from the potting material 72.

In one embodiment, the light guide 56 is overmolded on the cover 54 in order to form the casing 52.

In one other embodiment, the cover 54 may be overmolded on the light guide 56 in order to form the casing 52.

Advantageously, the cover 54 and the light guide 56 are made from a polymer. Advantageously, the light guide 56 is made of a translucent polymer so that the light emitted by the light emitter 50 goes through the light guide 56 and the through-hole 60.

What is claimed is:

1. A sensor module configured to detect a mechanical vibration of a component, the sensor module comprising:
a base configured to be secured on the component;
a light emitter;
a circuit board mechanically connected to the base and having a first side facing the base and a second side facing away from the base, the light emitter being disposed on the second side; and
a casing inside which is housed the circuit board,
wherein the casing comprises a cover and a light guide facing the light emitter, the cover comprising a through-hole through which the light emitted by the light emitter is able to pass and inside which extends the light guide, one of the cover or the light guide being overmolded on the other.

2. The sensor module according to claim 1, wherein the cover comprises a front part comprising the through-hole, and a mounting skirt extending from the front part and surrounding the circuit board.

3. The sensor module according to claim 1, wherein the through-hole has a conical form.

4. The sensor module according to claim 1, wherein the light guide is made of a translucent material.

5. The sensor module according to claim 1, wherein the light guide comprises a main base and a tube extending from the main base towards the light emitter, the main base being in contact with the cover all around the through-hole of the cover, and the tube surrounding the light emitter, the width of the tube being larger than the width of the light emitter.

6. The sensor module according to claim 5, wherein the tube rests against the second side of the circuit board.

7. The sensor module according to claim 1, comprising a potting material between the casing and the second side of the circuit board.

8. The sensor module according to claim 7, wherein the potting material comprises a polymer.

9. The sensor module according to claim 1, wherein the circuit board comprises a piezoelectric vibration sensor.

10. The sensor module according to claim 2, wherein the through-hole has a conical form.

11. The sensor module according to claim 10, wherein the light guide is made of a translucent material.

12. The sensor module according to claim 11, wherein the light guide comprises a main base and a tube extending from the main base towards the light emitter, the main base being in contact with the cover all around the through-hole of the cover, and the tube surrounding the light emitter, the width of the tube being larger than the width of the light emitter.

13. The sensor module according to claim 12, wherein the tube rests against the second side of the circuit board.

14. The sensor module according to claim 13, comprising a potting material between the casing and the second side of the circuit board.

15. The sensor module according to claim 14, wherein the potting material comprises a polymer.

16. The sensor module according to claim 15, wherein the circuit board comprises a piezoelectric vibration sensor.

17. A vehicle wheel assembly comprising:
a wheel having a component comprising studs and;
a sensor module according to claim 16 mounted on the studs of the wheel.

18. A vehicle wheel assembly comprising:
a wheel having a component comprising studs and;
a sensor module according to claim 1 mounted on the studs of the wheel.
